(19) United States
(12) Patent Application Publication
(10) Pub. No.: US 2021/0387199 A1
(43) Pub. Date: Dec. 16, 2021

(54) WATER BATH DEVICE FOR TOMOGRAPHICALLY PLASTINATED SPECIMENS AND WATER BATH HARDENING METHOD THEREOF

(71) Applicant: DALIAN MEDICAL UNIVERSITY, DALIAN (CN)

(72) Inventors: Hongjin Sui, Dalian (CN); Jianfei Zhang, Dalian (CN)

(21) Appl. No.: 17/460,279

(22) Filed: Aug. 29, 2021

Related U.S. Application Data
(63) Continuation of application No. PCT/CN2021/073769, filed on Jan. 26, 2021.

(30) Foreign Application Priority Data
Feb. 13, 2020 (CN) 202010090888.8

(51) Int. Cl. B01L 7/02; G01N 1/36; G01N 1/44; G01N 1/30

(52) U.S. Cl. CPC B01L 7/02; G01N 1/30; G01N 1/44; G01N 1/36

(57) ABSTRACT

A water bath device for tomographically plastinated specimens and a water bath hardening method thereof comprises a water bath box, a control box, heating tubes, a water circulation assembly and positioning grids. The heating tubes are provided inside the water bath box. The water circulation assembly comprises a water circulation pipeline, a circulating water pump and a drain outlet. The two sides of the inner walls of the water bath box are provided with positioning grids opposite each other. After infiltration, a vertical embedding box is inserted between the positioning grids in the water bath box, and a tomographically plastinated specimen is hardened by water bathing. The equipment is simple and the temperature is easily controlled The excess heat can be quickly transferred to the water as well to ensure a stable temperature during the hardening process, which effectively avoids the occurrence of an explosive polymerization phenomenon.

### TECHNICAL FIELD

The present invention relates to the field of biotechnology detection, and in particular to a water bath device for tomographically plastinated specimens and a water bath hardening method thereof.

### BACKGROUND ART

In a traditional tomographically plastinated specimen manufacturing process, specimens are hardened by ultraviolet irradiation. After plastinated slices are dehydrated, they are then put in polymers for infiltration. The slices that have been infiltrated are placed into a mold similar to a shallow tray that is enclosed circumferentially. The mold is put in place, and polymers are re-injected. Then the mold is sealed circumferentially and placed horizontally. An ultraviolet lamp is placed above and below a glass plate box for irradiation to harden the slices. When this method is used to harden tomographic slices, the temperature needs to be raised at the beginning to initiate polymerization of polymers. After the polymerization starts, the polymers will release a lot of thermal energy. At this time, the heat of the polymerization needs to be released to avoid excessive temperature and explosive polymerization. Therefore, an air convection device is required to ensure heat dissipation. The use of ultraviolet irradiation for the hardening process has the following disadvantages: firstly, much heat is generated, the heat dissipation is slow, and the superposition of ultraviolet lamp irradiation and heat generation after polymerization makes it impossible for the slices in the glass plate box to transfer heat out quickly; secondly, the temperature is not easily controlled flexibly, which often causes explosive polymerization; thirdly, non-uniform heating will cause deformation of the slices; and fourthly, the hardening equipment is complicated.

### SUMMARY OF THE INVENTION

The technical problem to be solved by the present invention is to overcome the shortcomings in the prior art and provide a water bath device for tomographically plastinated specimens and a water bath hardening method thereof.

The present invention is implemented by the following technical solutions:

A water bath device for tomographically plastinated specimens, characterized by comprising a water bath box, a control box provided in the water bath box, heating tubes, a water circulation assembly, and positioning grids, wherein the upper surface of the water bath box is open, the heating tubes are provided inside the water bath box, the heating tubes are electrically connected to the control box, the water circulation assembly comprises a water circulation pipeline, a circulating water pump provided on the water circulation pipeline, and a drain outlet provided on a side wall of the water bath box, and the two sides of the inner walls of the water bath box are provided with positioning grids opposite each other.

According to the above technical solution, preferably, the water circulation pipeline and the circulating water pump are provided in the control box, one end of the water circulation pipeline is provided with a circulating water inlet which is communicated to the outside of the control box, the control box is provided with a plurality of circulating water outlets on a side wall, and the other end of the water circulation pipeline is communicated with the circulating water outlets.

According to the above technical solution, preferably, a thermostat is provided in the control box, and the thermostat is electrically connected to the heating tubes.

According to the above technical solution, preferably, the heating tubes are provided close to the bottom surface of the water bath box.

According to the above technical solution, preferably, the heating tubes are provided close to the side wall of the water bath box.

According to the above technical solution, preferably, the side wall of the water bath box has a multi-layer structure, and the inner layer of the side wall of the water bath box is filled with a thermal insulation layer.

According to the above technical solution, preferably, the structure of the water bath box is a cuboid or a cylinder.

The present invention also discloses a water bath hardening method for tomographically plastinated specimens, in which the water bath device for tomographically plastinated specimens is used, characterized by comprising the following steps: a. dehydrating a plastinated slice, then putting it in a vertical embedding box; b. pouring liquid medicine into the vertical embedding box, and putting it in a vacuum box for vacuum infiltration; c. vertically inserting, after the infiltration is completed, the vertical embedding box between positioning grids in the water bath box, and carrying out water bath hardening by means of the water bath box; and d. taking out, after the liquid medicine is completely polymerized, the plastinated slice from the vertical embedding box.

According to the above technical solution, preferably, step a comprises: coating a sealing strip on the surface of one piece of tempered glass, and providing two pieces of tempered glass opposite each other through the sealing strip to form a flat vertical space with one open upper end and the other three sides sealed; fixing the surrounding three sides of the two pieces of tempered glass by fixing clips in an assisted manner; and inserting the plastinated slice between the two pieces of tempered glass from the open upper end.

According to the above technical solution, preferably, step a comprises: placing the plastinated slice on the surface of one piece of tempered glass; coating the surface of the tempered glass around the plastinated slice with a sealing strip, and providing two pieces of tempered glass opposite each other through the sealing strip to form a flat vertical space with one open upper end and the other three sides sealed; and fixing the surrounding three sides of the two pieces of tempered glass by fixing clips in an assisted manner.

The beneficial effects of the present invention are as follows:

After infiltration, a vertical embedding box is inserted between the positioning grids in the water bath box, and a tomographically plastinated specimen is hardened by water bathing. The equipment is simple and the temperature is easily controlled. It has strong convection and quick heat conduction during heating and cooling, because water is a good conductor of heat. When the temperature needs to be raised at the beginning of curing, the heat of the water is transferred to the vertical glass box to raise the temperature of polymers in the box. After the polymerization is initiated, the temperature of polyesters rises and needs to be cooled. The excess heat can be quickly transferred to the water as well to ensure a stable temperature during the hardening process, which effectively avoids the occurrence of an explosive polymerization phenomenon. In addition, because the vertical embedding box is immersed in water and is in close contact with the water, it results in uniform heating and the slice is not easy to deform.

### BRIEF DESCRIPTION OF THE DRAWINGS

FIG. 1 is a schematic top view of the structure of the present invention.

FIG. 2 is a schematic side view of the structure of a control box part of the present invention.

FIG. 3 is a schematic front view of the structure of a vertical embedding box part of the present invention.

FIG. 4 is a schematic side view of the structure of the vertical embedding box part of the present invention.

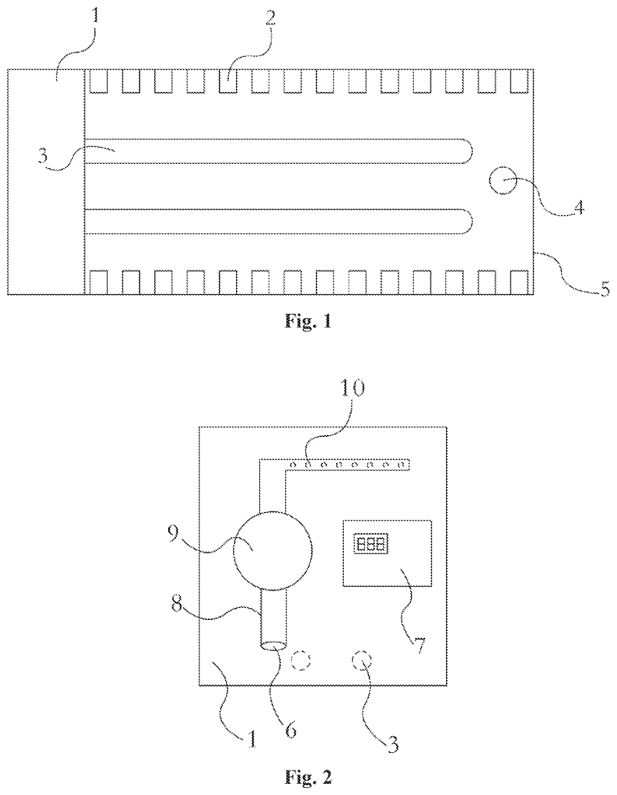

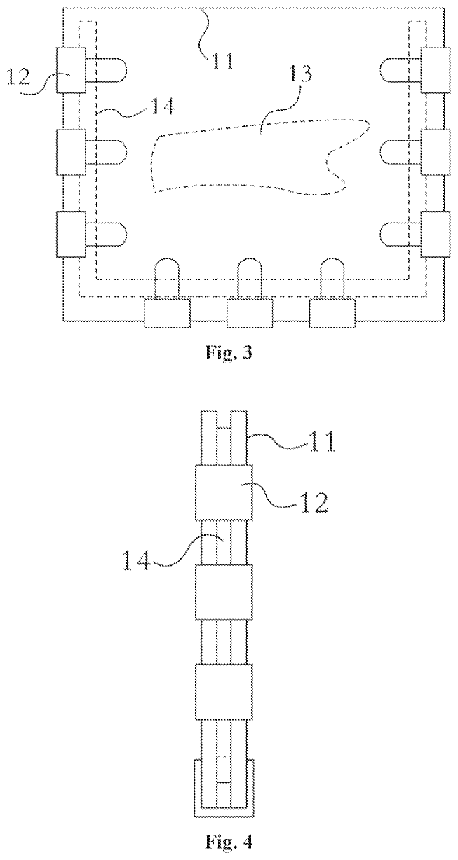

In the figures: 1. control box; 2. positioning grid; 3. heating tube; 4. drain outlet; 5. water bath box; 6. circulating water inlet; 7. thermostat; 8. water circulation pipeline; 9. circulating water pump; 10. circulating water outlet; 11. tempered glass; 12. fixing clip; 13. plastinated slice; 14. sealing strip.

### DETAILED DESCRIPTION OF EMBODIMENTS

In order to enable those skilled in the art to better understand the technical solutions of the present invention, the present invention will be further described in detail below with reference to the accompanying drawings and the preferred embodiments.

As shown in the figures, the present invention comprises a water bath box 5, a control box 1 provided in the water bath box 5, heating tubes 3, a water circulation assembly, and positioning grids 2. The upper surface of the water bath box 5 is open. The heating tubes 3 are provided inside the water bath box 5. The heating tubes 3 are electrically connected to the control box 1. The water circulation assembly comprises a water circulation pipeline 8, a circulating water pump 9 provided on the water circulation pipeline 8, and a drain outlet 4 provided on a side wall of the water bath box 5. The two sides of the inner walls of the water bath box 5 are provided with positioning grids 2 opposite each other. After infiltration, a vertical embedding box is inserted between the positioning grids 2 in the water bath box 5, and a tomographically plastinated specimen is hardened by water bathing. The equipment is simple and the temperature is easily controlled. It has strong convection and quick heat conduction during heating and cooling, because water is a good conductor of heat. When the temperature needs to be raised at the beginning of curing, the heat of the water is transferred to the vertical glass box to raise the temperature of polymers in the box. After the polymerization is initiated, the temperature of polyesters rises and needs to be cooled. The excess heat can be quickly transferred to the water as well to ensure a stable temperature during the hardening process, which effectively avoids the occurrence of an explosive polymerization phenomenon. In addition, because the vertical embedding box is immersed in water and is in close contact with the water, it results in uniform heating and the slice is not easy to deform.

According to the above embodiment, preferably, the water circulation pipeline 8 and the circulating water pump 9 are provided in the control box 1. One end of the water circulation pipeline 8 is provided with a circulating water inlet 6 which is communicated to the outside of the control box 1. The control box 1 is provided with a plurality of circulating water outlets 10 on a side wall, and the other end of the water circulation pipeline 8 is communicated with the circulating water outlets 10, such that water bodies in the water bath box 5 are continuously circulated and the temperature in the water bath box 5 is maintained equalized.

According to the above embodiment, preferably, a thermostat 7 is provided in the control box 1. The thermostat 7 is electrically connected to the heating tubes 3, and the set temperature of the thermostat 7 can be adjusted according to experimental requirements to maintain the water temperature in the box constant.

According to the above embodiment, preferably, the heating tubes 3 are provided close to the bottom surface of the water bath box 5.

According to the above embodiment, preferably, the heating tubes 3 are provided close to the side wall of the water bath box 5. There can be a plurality of heating tubes 3 at various positions in the water bath box 5, and the power of the heating tubes 3 can be changed by adjusting the thermostat 7 to keep the uniform heating and constant water temperature in the water bath box 5.

According to the above embodiment, preferably, the side wall of the water bath box 5 has a multi-layer structure, and the inner layer of the side wall of the water bath box 5 is filled with a thermal insulation layer to effectively avoid heat loss.

According to the above embodiment, preferably, the structure of the water bath box 5 is a cuboid or a cylinder.

The present invention also discloses a water bath hardening method for tomographically plastinated specimens, characterized by comprising the following steps: a. dehydrating a plastinated slice 13, then putting it in a vertical embedding box, wherein the vertical embedding box in this example is a fully enclosed or partially enclosed glass plate box made of two pieces of tempered glass 11 and a sealing material; b. pouring liquid medicine into the vertical embedding box, and putting it in a vacuum box for vacuum infiltration; c. vertically inserting, after the infiltration is completed, the vertical embedding box between positioning grids 2 in the water bath box 5, and carrying out water bath hardening by means of the water bath box 5; and d. taking out, after the liquid medicine is completely polymerized, the plastinated slice 13 from the vertical embedding box to obtain a finished slice after removing the double-sided tempered glass 11 of the vertical embedding box.

According to the above embodiment, preferably, step a comprises: coating a sealing strip 14 on the surface of one piece of tempered glass 11, and providing two pieces of tempered glass 11 opposite each other through the sealing strip 14 to form a flat vertical space with one open upper end and the other three sides sealed; fixing the surrounding three sides of the two pieces of tempered glass 11 by fixing clips 12 in an assisted manner; and inserting the plastinated slice 13 between the two pieces of tempered glass 11 from the open upper end. The vertical embedding box in this example is a vertical glass plate box made of two pieces of tempered glass 11 and a sealing strip 14, which has three sides enclosed and an opening facing upwards. Since the upper end of the embedding box is not sealed, acetone will escape from the top of the embedding box in the form of air bubbles during the vacuum infiltration process, so that there is no need to add polymers twice before curing, thus reducing process steps and drug consumption.

According to the above embodiment, preferably, step a comprises: placing the plastinated slice 13 on the surface of one piece of tempered glass 11; coating the surface of the tempered glass 11 around the plastinated slice 13 with a sealing strip 14, and providing two pieces of tempered glass 11 opposite each other through the sealing strip 14 to form a flat vertical space with one open upper end and the other three sides sealed; and fixing the surrounding three sides of the two pieces of tempered glass 11 by fixing clips 12 in an assisted manner. The vertical embedding box in this example is a vertical glass plate box made of two pieces of tempered glass 11 and a sealing strip 14, which has three sides enclosed and an opening facing upwards. Since the upper end of the embedding box is not sealed, acetone will escape from the top of the embedding box in the form of air bubbles during the vacuum infiltration process, so that there is no need to add polymers twice before curing, thus reducing process steps and drug consumption.

After infiltration, a vertical embedding box is inserted between the positioning grids 2 in the water bath box 5, and a tomographically plastinated specimen is hardened by water bathing. The equipment is simple and the temperature is easily controlled. It has strong convection and quick heat conduction during heating and cooling, because water is a good conductor of heat. When the temperature needs to be raised at the beginning of curing, the heat of the water is transferred to the vertical glass box to raise the temperature of polymers in the box. After the polymerization is initiated, the temperature of polyesters rises and needs to be cooled. The excess heat can be quickly transferred to the water as well to ensure a stable temperature during the hardening process, which effectively avoids the occurrence of an explosive polymerization phenomenon. In addition, because the vertical embedding box is immersed in water and is in close contact with the water, it results in uniform heating and the slice is not easy to deform.

The above descriptions are merely preferred embodiments of the present invention. It should be noted that for those of ordinary skill in the art, several improvements and modifications can be made without departing from the principle of the present invention, and these improvements and modifications are also should be considered within the protection scope of the present invention.

1. A water bath device for tomographically plastinated specimens, wherein comprising a water bath box, a control box provided in the water bath box, heating tubes, a water circulation assembly, and positioning grids, wherein the upper surface of the water bath box is open, the heating tubes are provided inside the water bath box, the heating tubes are electrically connected to the control box, the water circulation assembly comprises a water circulation pipeline, a circulating water pump provided on the water circulation pipeline, and a drain outlet provided on a side wall of the water bath box, and the two sides of the inner walls of the water bath box are provided with positioning grids opposite each other.

2. The water bath device for tomographically plastinated specimens according to claim 1, wherein the water circulation pipeline and the circulating water pump are provided in the control box, one end of the water circulation pipeline is provided with a circulating water inlet which is communicated to the outside of the control box, the control box is provided with a plurality of circulating water outlets on a side wall, and the other end of the water circulation pipeline is communicated with the circulating water outlets.

3. The water bath device for tomographically plastinated specimens according to claim 2, wherein a thermostat is provided in the control box, and the thermostat is electrically connected to the heating tubes.

4. The water bath device for tomographically plastinated specimens according to claim 3, wherein the heating tubes are provided close to the bottom surface of the water bath box.

5. The water bath device for tomographically plastinated specimens according to claim 3, wherein the heating tubes are provided close to the side wall of the water bath box.

6. The water bath device for tomographically plastinated specimens according to claim 4, wherein the heating tubes are provided close to the side wall of the water bath box.

7. The water bath device for tomographically plastinated specimens according to claim 1, wherein the side wall of the water bath box has a multi-layer structure, and the inner layer of the side wall of the water bath box is filled with a thermal insulation layer.

8. The water bath device for tomographically plastinated specimens according to claim 1, wherein the structure of the water bath box is a cuboid or a cylinder.

9. The water bath device for tomographically plastinated specimens according to claim 7, wherein the structure of the water bath box is a cuboid or a cylinder.

10. A water bath hardening method for tomographically plastinated specimens, in which the water bath device for tomographically plastinated specimens according to claim 1 is used, wherein comprising the following steps: a. dehydrating a plastinated slice, then putting it in a vertical embedding box; b. pouring liquid medicine into the vertical embedding box, and putting it in a vacuum box for vacuum infiltration; c. vertically inserting, after the infiltration is completed, the vertical embedding box between positioning grids in the water bath box, and carrying out water bath hardening by means of the water bath box; and d. taking out, after the liquid medicine is completely polymerized, the plastinated slice from the vertical embedding box.

11. A water bath hardening method for tomographically plastinated specimens, in which the water bath device for tomographically plastinated specimens according to claim 3 is used, wherein comprising the following steps: a. dehydrating a plastinated slice, then putting it in a vertical embedding box; b. pouring liquid medicine into the vertical embedding box, and putting it in a vacuum box for vacuum infiltration; c. vertically inserting, after the infiltration is completed, the vertical embedding box between positioning grids in the water bath box, and carrying out water bath hardening by means of the water bath box; and d. taking out, after the liquid medicine is completely polymerized, the plastinated slice from the vertical embedding box.

12. A water bath hardening method for tomographically plastinated specimens, in which the water bath device for tomographically plastinated specimens according to claim 7 is used, wherein comprising the following steps: a. dehydrating a plastinated slice, then putting it in a vertical embedding box; b. pouring liquid medicine into the vertical embedding box, and putting it in a vacuum box for vacuum infiltration; c. vertically inserting, after the infiltration is completed, the vertical embedding box between positioning grids in the water bath box, and carrying out water bath hardening by means of the water bath box; and d. taking out, after the liquid medicine is completely polymerized, the plastinated slice from the vertical embedding box.

13. The water bath hardening method for tomographically plastinated specimens according to claim 10, wherein step a comprises: coating a sealing strip on the surface of one piece of tempered glass, and providing two pieces of tempered glass opposite each other through the sealing strip to form a flat vertical space with one open upper end and the other three sides sealed; fixing the surrounding three sides of the two pieces of tempered glass by fixing clips in an assisted manner; and inserting the plastinated slice between the two pieces of tempered glass from the open upper end.

14. The water bath hardening method for tomographically plastinated specimens according to claim 11, wherein step a comprises: coating a sealing strip on the surface of one piece of tempered glass, and providing two pieces of tempered glass opposite each other through the sealing strip to form a flat vertical space with one open upper end and the other three sides sealed; fixing the surrounding three sides of the two pieces of tempered glass by fixing clips in an assisted manner; and inserting the plastinated slice between the two pieces of tempered glass from the open upper end.

15. The water bath hardening method for tomographically plastinated specimens according to claim 12, wherein step a comprises: coating a sealing strip on the surface of one piece of tempered glass, and providing two pieces of tempered glass opposite each other through the sealing strip to form a flat vertical space with one open upper end and the other three sides sealed; fixing the surrounding three sides of the two pieces of tempered glass by fixing clips in an assisted manner; and inserting the plastinated slice between the two pieces of tempered glass from the open upper end.

16. The water bath hardening method for tomographically plastinated specimens according to claim 10, wherein step a comprises: placing the plastinated slice on the surface of one piece of tempered glass; coating the surface of the tempered glass around the plastinated slice with a sealing strip, and providing two pieces of tempered glass opposite each other through the sealing strip to form a flat vertical space with one open upper end and the other three sides sealed; and fixing the surrounding three sides of the two pieces of tempered glass by fixing clips in an assisted manner.

17. The water bath hardening method for tomographically plastinated specimens according to claim 11, wherein step a comprises: placing the plastinated slice on the surface of one piece of tempered glass; coating the surface of the tempered glass around the plastinated slice with a sealing strip, and providing two pieces of tempered glass opposite each other through the sealing strip to form a flat vertical space with one open upper end and the other three sides sealed; and fixing the surrounding three sides of the two pieces of tempered glass by fixing clips in an assisted manner.

18. The water bath hardening method for tomographically plastinated specimens according to claim 12, wherein step a comprises: placing the plastinated slice on the surface of one piece of tempered glass; coating the surface of the tempered glass around the plastinated slice with a sealing strip, and providing two pieces of tempered glass opposite each other through the sealing strip to form a flat vertical space with one open upper end and the other three sides sealed; and fixing the surrounding three sides of the two pieces of tempered glass by fixing clips in an assisted manner.
